(19) United States
(12) Patent Application Publication
(10) Pub. No.: US 2022/0371359 A1
(43) Pub. Date: Nov. 24, 2022

(54) DECORATIVE CONCRETE WALL SURFACES

(71) Applicants: Julian NASSER, Hillsborough, CA (US); Kamran NASSER, Hillsborough, CA (US)

(72) Inventors: Julian NASSER, Hillsborough, CA (US); Kamran NASSER, Hillsborough, CA (US)

(21) Appl. No.: 17/328,023

(22) Filed: May 24, 2021

(51) Int. Cl. B44C 1/20; E04F 13/02

(52) U.S. Cl. CPC B44C 1/20; E04F 13/02

(57) ABSTRACT

Methods of creating decorative concrete wall surfaces, the methods including dividing an area of a wall surface into multiple sections; marking a boundary between each pair of adjacent sections; selecting a desired width for the border area between adjacent sections; applying a cement-based slurry to each section of the wall surface using a roller brush, so each section receives at least two coats of the slurry, and each border area receives at least four coats of the slurry; smoothing the surface of the applied slurry in each section; and permitting the applied slurry to dry to form the decorative concrete wall surface.

### TECHNICAL FIELD

This disclosure relates to the preparation of decorative wall surfaces, and more particularly to methods of preparing decorative wall surfaces that are intended to resemble concrete walls, and the resulting decorative wall surfaces themselves.

### BACKGROUND

Concrete is a popular building material, and over time a number of architectural styles have developed that can incorporate the use of concrete to create their distinctive appearances, such as Bauhaus architecture, brutalist architecture, and modern architecture, among others.

It may be desirable to alter the appearance of an existing structure by replacing some of the materials used in its construction with concrete. Unfortunately, concrete construction is typically both thicker and heavier than other building materials, and remodeling an existing structure using concrete construction techniques can be either physically or economically impractical.

What is needed is a method of changing the appearance of an existing structure by creating the appearance of concrete surfaces, without the difficulty and cost of actual concrete construction.

### SUMMARY

The present disclosure is directed to methods of preparing decorative wall surfaces, and in particular to methods of preparing decorative concrete wall surfaces, and the decorative wall surfaces themselves.

In some embodiments, the disclosure is directed to methods of creating decorative concrete wall surfaces, where the methods include dividing an area of a wall surface into a plurality of sections, marking a boundary between each pair of adjacent sections, selecting a desired border width area along the boundary between each pair of adjacent sections, applying a cementitious slurry to each section of the wall surface using a roller brush such that each section receives at least two coats of the cementitious slurry, and each border area receives at least four coats of the cementitious slurry, smoothing a surface of the applied cementitious slurry in each section, and permitting the applied cementitious slurry to dry to form the decorative wall surface.

In some embodiments, the disclosure is directed to methods of creating decorative concrete wall surfaces, where the methods include dividing an area of a wall surface into a plurality of sections so that each section is a member of an adjacent pair of sections and a member of an opposing pair of sections, where adjacent pairs of sections share a common boundary, and opposing pairs of sections share a common vertex; marking a boundary between each pair of adjacent sections using a laser level; selecting a desired border width area along the boundary between each pair of adjacent sections that is between 1/16 inch and ½ inch; preparing a cementitious slurry by adding water to a dry calcium sulfoaluminate cement composition that includes a granular aggregate; applying at least two coats of the cementitious slurry to a first set of opposing sections of the wall surface using a roller brush, including the border area of the opposing sections; smoothing a surface of the applied coats in the first set of opposing sections of the wall surface using a straight edge; applying at least two coats of the cementitious slurry to a second set of opposing sections of the wall surface using the roller brush, including an overlapping application of the cementitious slurry to the border area of the borders shared with the first set of opposing sections, such that each border area receives at least four coats of the cementitious slurry; smoothing a surface of the applied coats in the second set of opposing sections of the wall surface using a straight edge; and permitting the applied coats of the cementitious slurry to dry to form the decorative wall surface.

In some embodiments, the disclosure is directed to decorative concrete wall surfaces, where the decorative concrete wall surfaces are prepared by dividing an area of a wall surface into a plurality of sections; marking a boundary between each pair of adjacent sections; selecting a desired border width along the boundary between each pair of adjacent sections; applying a cementitious slurry to each section of the wall surface using a roller brush, such that each section receives at least two coats of the cementitious slurry, and each border receives at least four coats of the cementitious slurry; smoothing a surface of the applied cementitious slurry in each section; and permitting the applied cementitious slurry to dry to form the decorative wall surface.

The disclosed steps, features, and advantages of the methods and decorative walls may be achieved independently in various embodiments of the present disclosure, or may be combined in yet other embodiments, further details of which can be seen with reference to the following description and drawings.

### BRIEF DESCRIPTION OF THE DRAWINGS

FIG. 1 depicts a wall surface suitable for being converted into an exemplary decorative concrete wall surface according to the present disclosure.

FIGS. 2A-2D depict alternative methods of dividing an area of the wall surface into a plurality of sections, according to an aspect of the present disclosure.

FIG. 3 depicts the wall surface of FIG. 1 after marking the wall surface with boundaries between adjacent sections.

FIG. 4 depicts an application of a masking material to the wall surface so as to outline two opposing sections of the wall surface.

FIG. 5 depicts an enlarged detail of FIG. 4 showing the masking material applied at a vertex of the two opposing sections of the wall surface.

FIG. 6 depicts the vertex of the opposing sections of the wall surface of FIG. 5 showing how the masking material may be trimmed.

FIG. 7 depicts the preparation of a cementitious slurry by mixing a cement formulation with water.

FIG. 8 depicts the cementitious slurry with a paint grid and a roller brush for application to the wall surface.

FIG. 9 depicts the application of a cementitious slurry to each of the masked opposing sections of the wall surface.

FIG. 10 depicts the wall surface of FIG. 9 after the masking material is removed.

FIG. 11 depicts an application of a masking material to the wall surface so as to outline the remaining two sections, and define a border area between adjacent sections of the wall surface.

FIG. 12 depicts the wall surface of FIG. 11 after the masking material is trimmed.

FIG. 13 depicts the application of the cementitious slurry to each of the remaining sections of the wall surface.

FIG. 14 depicts the wall surface after each section of the wall surface has received at least two coats of the cementitious slurry, and each border area has received at least four coats of the cementitious slurry.

FIG. 15 depicts an enlarged detail of FIG. 14, showing the border areas between adjacent sections of the wall surface, where the border areas are visually distinct due to the additional coats of cementitious slurry received in those areas.

FIG. 16. is a flowchart illustrating an exemplary method according to the present disclosure.

FIG. 17 is a flowchart illustrating an alternative exemplary method according to the present disclosure.

### DETAILED DESCRIPTION

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

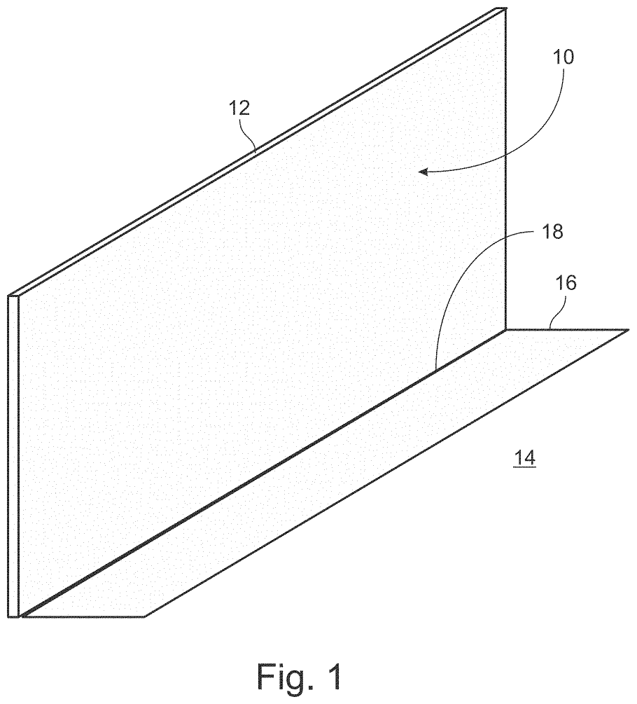

FIG. 1 depicts a representative wall surface 10, prior to applying a decorative concrete surface according to the present disclosure. Wall surface 10 typically corresponds to an outer surface of an exemplary wall structure 12. Wall surface 10 may be the surface of any number of different types of wall structure 12, including drywall or gypsum board, veneer plaster, wooden planks, or engineered wood products, among others. Where the wall surface is the surface of an engineered wood product, the engineered wood product can include plywood, oriented strand board, laminated veneer lumber, parallel strand lumber, and fiberboard or chipboard, among others.

### Preparation

Wall surface 10 may be prepared prior to application of the desired decorative concrete surface. For example, wall surface 10 may be cleaned to remove any oils, waxes, greases, wallpaper, glue, dust, or any other materials that may compromise the adhesion of the concrete surface. Additionally, it may be desirable to remove any pictures, shelving, decorations, or other projecting features such as nails and screws from wall surface 10.

Similarly, it may be desirable to mask any areas on or near wall surface 10 that might be damaged by the applied concrete. For example, it may be desirable to mask electrical outlets, registers, baseboard units, and adjacent wall surfaces or the ceiling. Such features may be masked by any suitable masking material, such as painter's tape or masking tape.

In particular, and as shown in FIG. 1, it is recommended to cover the floor 14 adjacent to wall surface 10 with a floor covering 16 to protect it. Floor covering 16 may include drop cloths, tarps, paper, plastic materials, and the like arranged along a bottom edge 18 of wall surface 10. Floor covering 16 may have any desired width and/or area, up to and including covering an entire floor of a room. Typically, floor covering 16 extend along the entire width of wall surface 10, and may extend at least 24 inches outwardly from bottom edge 18 of wall surface 10.

The methods of the present disclosure may be used to create wall surfaces that closely mimic the appearance and even the texture of a real concrete wall. The present methods can create a wall surface that has an appearance of being divided into multiple wall sections. The design can create the appearance of wall sections that are relatively closely spaced, so that the sections simulate the appearance of concrete blocks, or the wall sections can be sized so as to simulate the appearance of individual poured sections of concrete. Typically, the size and shape of the sections created, and so the visual impression given by the decorative wall section, is determined by the placement of proposed boundary lines 20 on wall surface 10, where boundary lines 20 define the size and shape of desired wall sections 24 on wall surface 10.

Desired boundary lines 20 may be drawn on wall surface 10 freehand, using a straight edge, or using any other tool or methodology. In one aspect of the present method, a laser marking tool 26 may be used to plan the location of desired boundary lines 20, and thereby plan the size and shape of planned wall sections 24. Any laser marking tool 26 that may help a user position boundary lines 20 on wall surface 10 by projecting a straight line 28 on wall surface 10 is a suitable laser marking tool for the purposes of the present disclosure. It may be desirable to employ a laser marking tool that incorporates a level, so that boundary lines 20 can be aligned with either a horizontal plane or a vertical plane. Alternatively, or in addition, it may be desirable to employ a laser marking tool that incorporates one or more pins, so that the laser marking tool may be attached to wall surface 10. Typically, each laser-projected straight line 28 is marked such as by tracing with a pencil or other marking tool, so that in combination the marked boundary lines 20 define a desired number of wall sections 24, and the wall sections so defined have a desired spacing and orientation.

Boundary lines 20 may be placed horizontally, or vertically, so as to simulate conventional concrete constructions. Alternatively, or in addition, one or more boundary lines 20 may be placed so that is oriented at an angle to one or both of the horizontal plane and the vertical plane. In either case, any pairs of adjacent boundary lines may be substantially parallel, or substantially nonparallel.

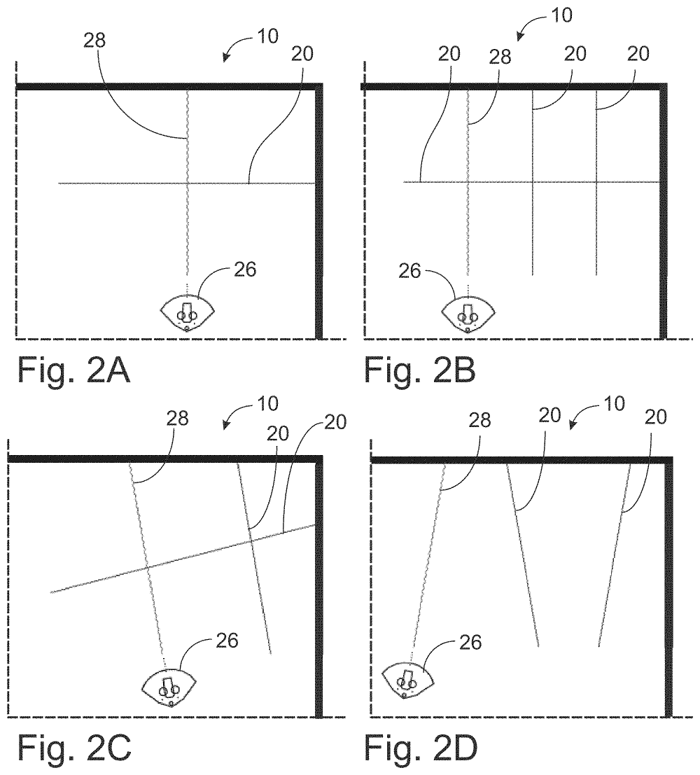

The placement of a variety of representative designs for a decorative concrete wall surface are shown in FIGS. 2A-2D. In FIG. 2A laser marking tool 26 is projecting a straight line 28 to assist placing making boundary lines 20 horizontally and vertically, so as to define relatively large wall sections 24. In contrast, FIG. 2B depicts the placement of horizontal and vertical boundary lines defining more closely arrayed wall sections 24. FIGS. 2C and 2D depict the marking of boundary lines 20 that are not limited to either horizontal or vertical orientation. In FIG. 2C the boundary lines 20 are arranged in parallel, while in FIG. 2D the boundary lines are placed in a more freeform fashion.

In one embodiment, wall surface 10 is divided into a plurality of wall sections that are each quadrilateral sections, such as squares or rectangles. The square or rectangular wall sections may be configured so that they are substantially equivalent to each other. In another embodiment, wall surface 10 is divided into a plurality of wall sections that are each parallelograms, where the parallelograms may be design so as to have substantially equivalent areas.

The boundary lines 20 between adjacent wall sections 24 will, eventually, correspond to a border area 30 having a defined width that will separate each pair of adjacent wall sections 24. Prior to application of cement to wall surface 10, a desired width for border areas 30 should be selected. According to the present methods, cement will be applied to wall surface 10 in such a way that each wall section 24 will receive at least two coats of the cement, while each border area 30 will receive at least four coats of the cement. In this way a visual contrast between wall sections 24 and border areas 30 may be created, and the appearance of concrete construction may be achieved.

Any method of applying cement to wall surface 10 that achieves at least two coats of cement upon each wall section and at least four coats of cement on each border area may be a satisfactory method for the purposes of the present methods. However, the following procedure may help facilitate the easy and fast application of cement in the desired manner, and provides excellent results.

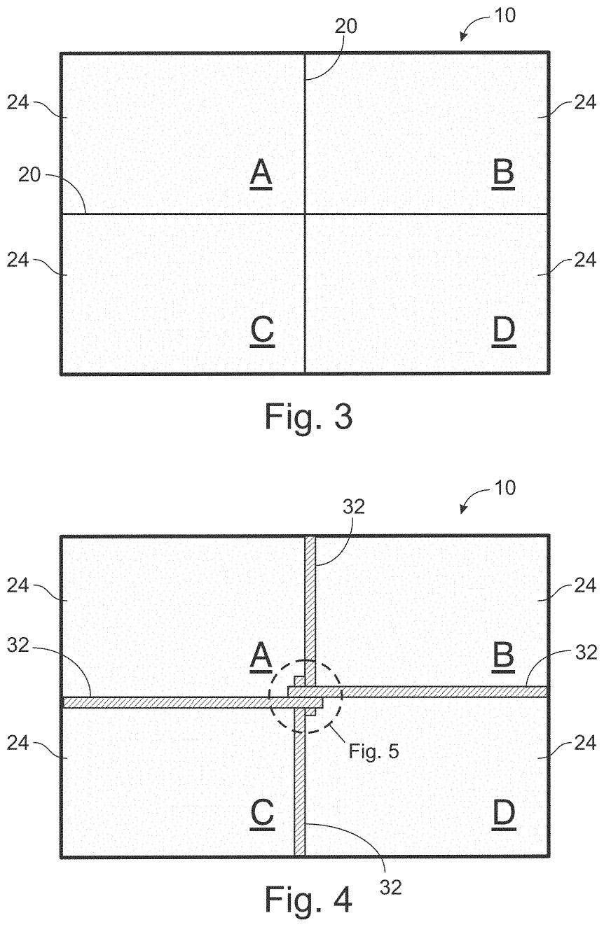

Once the desired number and configurations of wall sections 24 on wall surface 10 have been defined by boundary lines 20, the wall sections may be labeled to help facilitate the process of applying concrete to the wall. For example, as shown in FIG. 3, the four wall sections 24 are labeled A, B, C, and D. As shown, adjacent pairs of wall sections (e.g. A and B, A and C, B and D, and C and D) share a boundary line 20, while opposing wall sections (e.g. A and D, B and C) share a vertex.

The present method typically requires an initial selection of two opposing wall sections, such as wall sections A and D. As shown in FIG. 4, the boundaries of each of wall sections A and D are masked by a masking material 32, where masking material 32 may be painter's tape or masking tape, among other suitable masking materials. If the planned layout of wall sections includes additional pairs of opposing wall sections, they should be masked similarly.

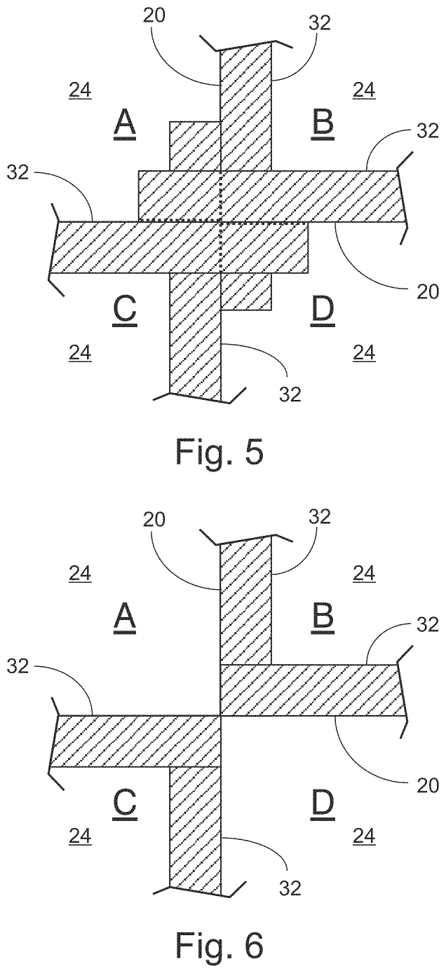

After its application, masking material 32 typically extends over boundary lines 20, as shown in FIG. 5, and details of the masking may need to be cleaned up. Using a sharp blade such as an XACTO knife or razor blade, the extra overlapping masking material 32 should be removed, so that the masking material 32 ends at the appropriate boundary line 20, as shown in FIG. 6. After masking material 32 is trimmed, wall sections A and D are cleanly outlined by masking material 32.

Once wall surface 10 has been prepared and wall sections A and D are masked, a cementitious slurry 34 should be prepared for application to the wall surface. As used herein, cementitious slurry 34 is a composition of cement combined with sufficient water that, when thoroughly mixed, creates a thick batch of semi-liquid concrete that can be applied to wall surface 10 using a roller brush 36.

Cementitious slurry 34 may be prepared by adding water to a dry cement composition containing a granular aggregate. The selection of an appropriate granular aggregate is important, as the type of aggregate used will affect the appearance and texture of the resulting wall surface. Preferably the granular aggregate is a relatively fine aggregate, and more preferably the granular aggregate is a silica sand.

The dry cement composition may include any suitable cement composition. Rapid-setting formulations of cement may be particularly preferred, such as formulations of concrete resurfacer that may be commercially available.

In particular, the use of a calcium sulfoaluminate cement composition may confer multiple advantageous properties on the resulting cementitious slurry. Calcium sulfoaluminate cements can be produced at lower temperatures, and with a lower lime content, and more conventional cement formulations. In addition calcium sulfoaluminate cement resists shrinkage during curing, which may lead to cracks. Calcium sulfoaluminate cement compositions may also provide relatively rapid setting, which is generally beneficial in the present methods.

A calcium sulfoaluminate concrete resurfacer formulation sold under the trade name RAPID SET NEWCRETE (CTS Cement manufacturing Corp, Garden Grove Calif.) is a particularly preferred cement composition for the purposes of the present methods.

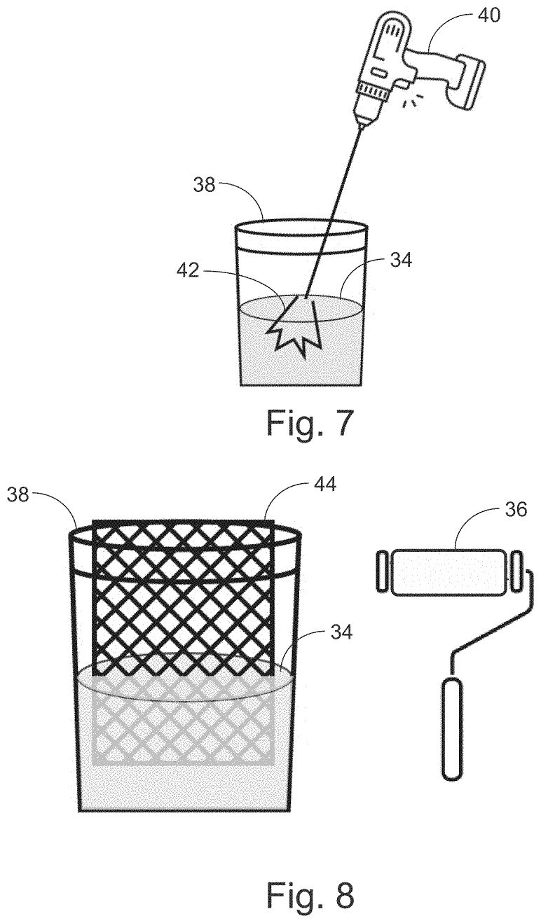

Cementitious slurry 34 may be prepared by adding water to the dry cement composition. No more than approximately five pounds of the cement composition should be mixed at one time, as sulfoaluminate cement compositions may set very rapidly. Cementitious slurry 34 may be prepared by mixing the cement composition with water in a proportion of 2 to 1. Cement composition 34 may be prepared in any suitable container, such as for example a bucket 38, and may be mixed by hand, or by using any suitable powered mixing apparatus, such as a drill 40 equipped with a mixing attachment 42, as shown in FIG. 7.

Any appropriate method of applying cementitious slurry 34 to the prepared wall surface 10 may be used. It may be advantageous, however, to apply cementitious slurry 34 to wall surface 10 using roller brush 36 in combination with a paint grid 44, such as may be inserted into bucket 38, as shown in FIG. 8.

During application, roller brush 36 should be soaked in cementitious slurry 34, and then rolled over grid 44 several times, until the cementitious slurry does not immediately run off the roller. The cementitious slurry should not be dripping too much from roller brush 36. Cementitious slurry 34 may then be applied using roller brush 36 as if it were paint.

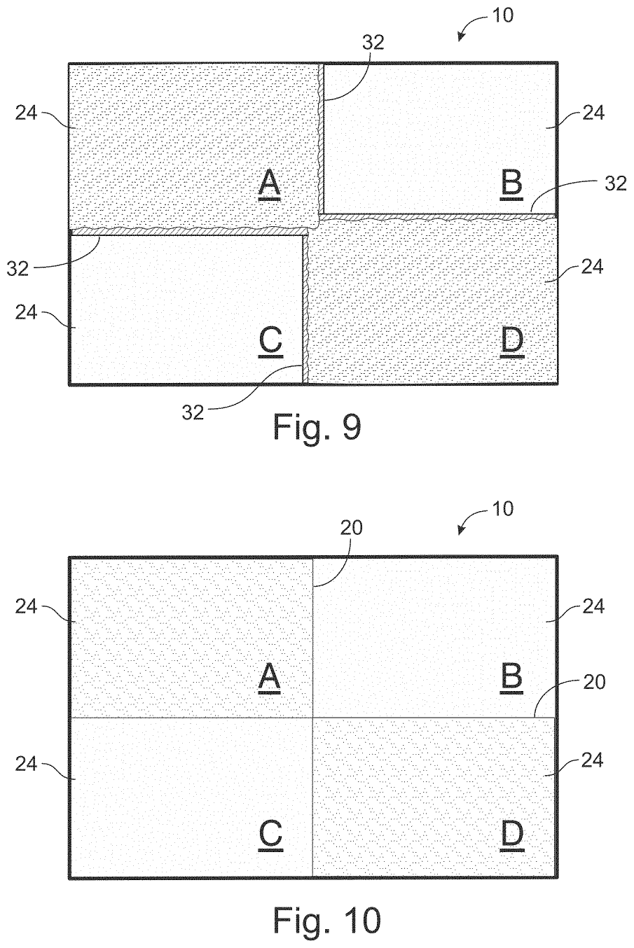

A thick coating of cementitious slurry 34 should be applied to each opposing wall section A and D, one section at a time. To ensure complete coverage, the cementitious slurry should overlap with masking material 32 by some amount during application, as shown in FIG. 9. For example, the cementitious slurry may overlap by about one-quarter inch onto masking material 32.

After wall sections A and D have been covered by cementitious slurry 34, they should be allowed to dry for a time sufficient for the cement to cure. Typically one hour is enough time for sections A and D to be sufficiently dry for application of a second coat of cement. A second coat of cementitious slurry 34 is then applied on each of wall sections A and D.

Immediately after the second coat of cement is applied, the surface of the coated wall sections should be smoothed. Typically, a straight edge may be used to smooth the cement coating, such as a putty knife or other scraper. In particular, a plastic putty knife provides good smoothing. The straight edge may be held at about a 35 degree angle to the wall surface as the straight edge is applied to the cement surface in a back-and-forth motion. Smoothing should be continued until the cement surface appears relatively even and smooth.

After smoothing, the cement surfaces of wall sections A and D should be permitted to dry and/or cure. This may require four or more hours for the wall surfaces to be sufficiently cured. Once dry, masking material 32 may be removed from the wall surface, leaving wall sections A and D covered with a concrete surface, and wall sections B and C unmodified, as shown in FIG. 10.

At this point, similarly to the masking of wall sections A and D, the boundaries of each of wall sections B and C are masked by masking material 32. However, instead of masking along boundary line 20, as was done for the previous wall sections, the masking will be offset from boundary line 20 by a width equal to the desired width of border area 30, such that border area 30 along boundary line 20 was originally coated during the coating of wall sections A and D, and will be again coated during the coating of wall sections B and C, due to the overlap permitted by the masking material offset.

In one embodiment, the offset of masking material 32 corresponding to the width of border area 39 is between 1/24 inch and ½ inch. In another embodiment, the offset of masking material 32 corresponding to the width of border area 39 is between 1/16 inch and ¼ inch.

FIG. 9 shows the application of masking material 32 along the boundary lines 20 of wall sections B and C, with the requisite offset exposing already coated segments of wall sections A and D. FIG. 10 shows the masking material 32 after the overlapping masking material near the vertex of the wall sections is cleaned up.

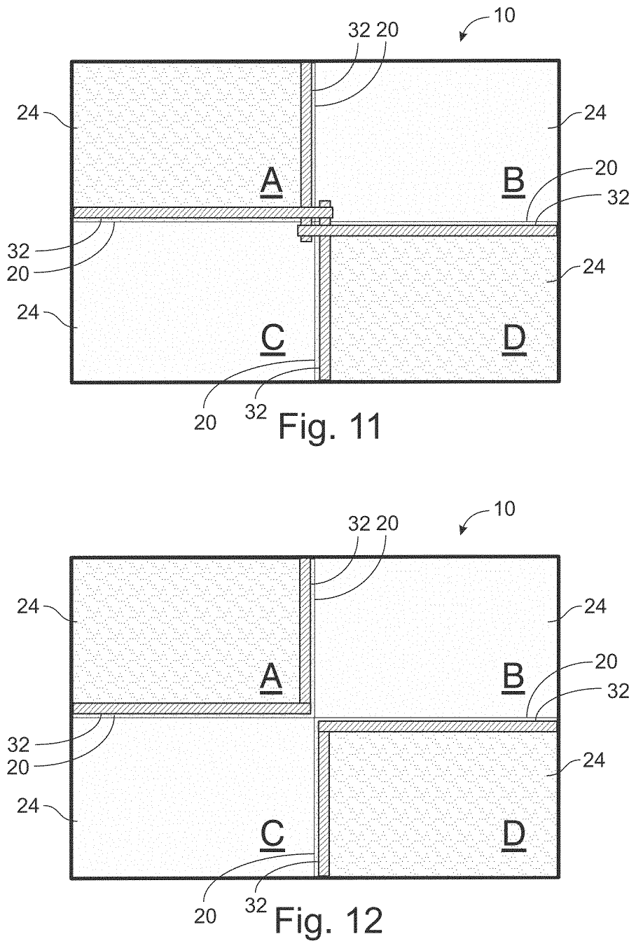

Once again, cementitious slurry 34 should be prepared for application to the wall surface, and applied to wall surface 10 using a roller brush 36 as described above. As shown in FIG. 11, the coating of cementitious slurry 34 overlaps with masking material 32 by some amount, typically by about one-quarter inch, onto masking material 32.

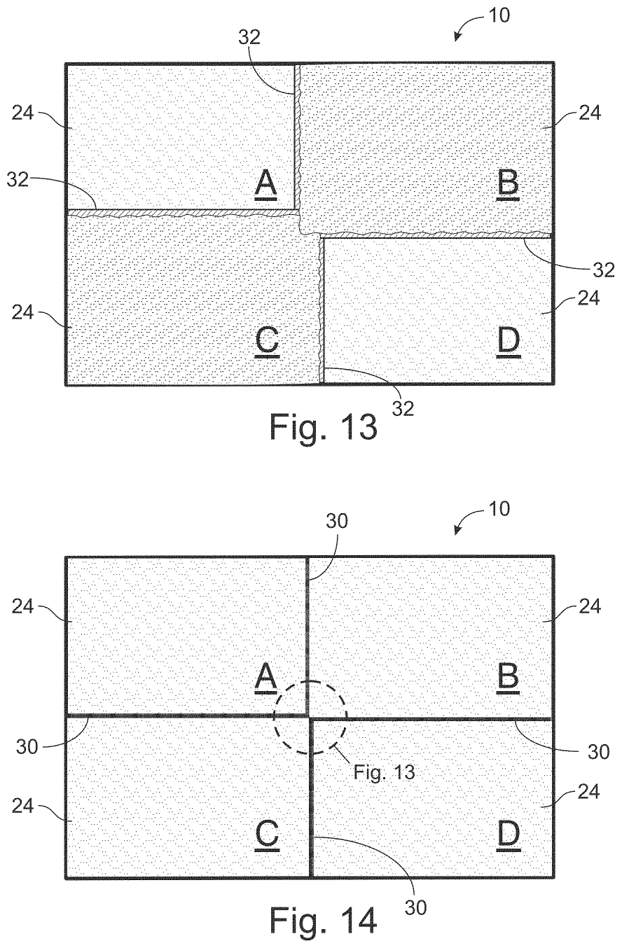

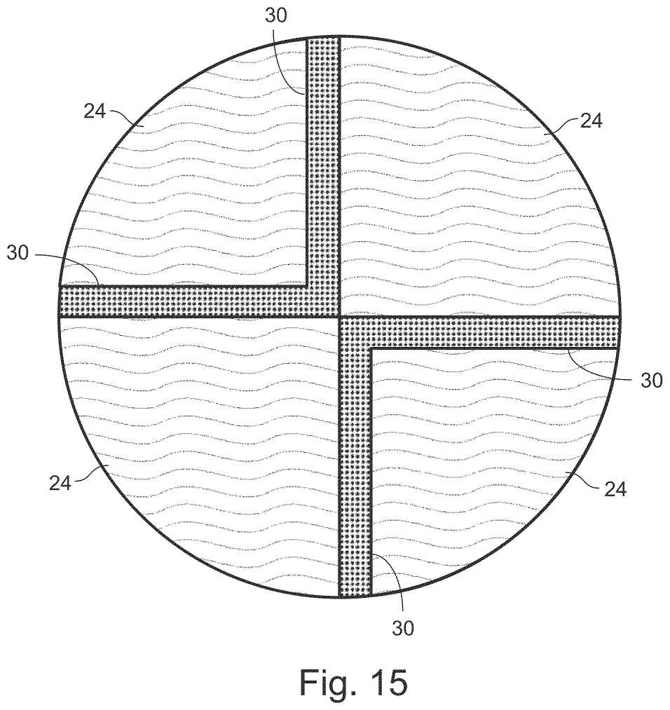

After wall sections B and C have been covered by cementitious slurry 34, they should be allowed to dry for a time sufficient for the cement to cure, and a second coat of cementitious slurry 34 should then be applied to each of wall sections B and C. After the wall sections B and C have been permitted to dry and/or cure for at least about four hours, the masking material can be removed. FIG. 12 depicts the resulting appearance of wall surface 10, with wall sections A, B, C, and D each having received at least two coats of the cementitious slurry, while the border area between adjacent sections has received at least four coats of the cementitious slurry. In order to more clearly show the border area that results from the offset masking of wall sections B and C, the vertex area of wall surface 10 is enlarged in FIG. 13, with border areas 30 being thicker, and therefore raised above the rest of the wall surface.

By carefully designing the layout of the desired wall sections, and the application of the cementitious slurry, a convincing appearance of concrete blocks or concrete sections can be achieved, at relatively low cost, without requiring extensive renovation, and without the weight load that would be required for actual concrete construction.

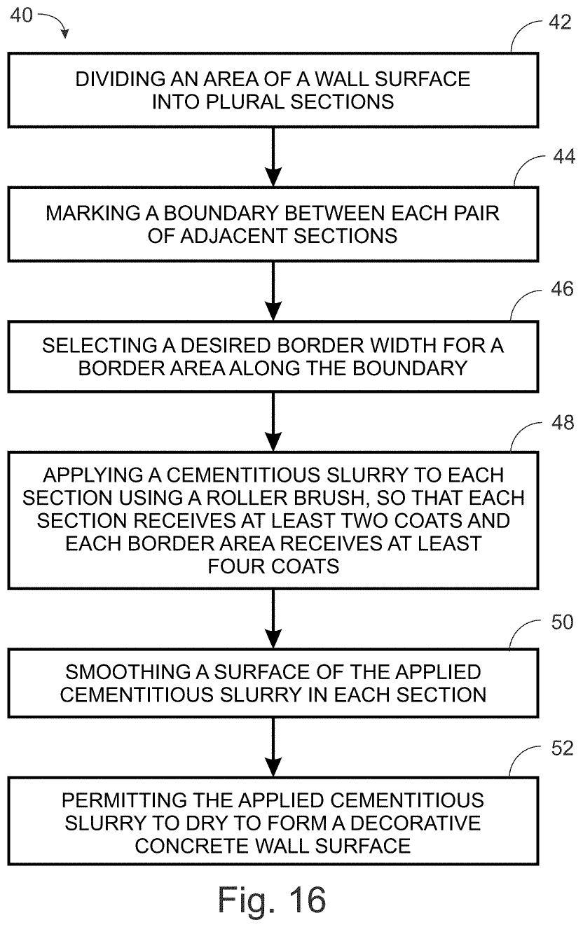

As described above via representative example, FIG. 16 is a flowchart 40 showing an illustrative method of creating a decorative concrete wall surface according to the present disclosure. Flowchart 40 includes the steps of dividing an area of a wall surface into a plurality of sections, at step 42; marking a boundary between each pair of adjacent sections, at step 44; selecting a desired border width area along the boundary between each pair of adjacent sections, at step 46; applying a cementitious slurry to each section of the wall surface using a roller brush, such that each section receives at least two coats of the cementitious slurry, and each border area receives at least four coats of the cementitious slurry, at step 48; smoothing a surface of the applied cementitious slurry in each section, at step 50; and permitting the applied cementitious slurry to dry to form the decorative concrete wall surface, at step 52.

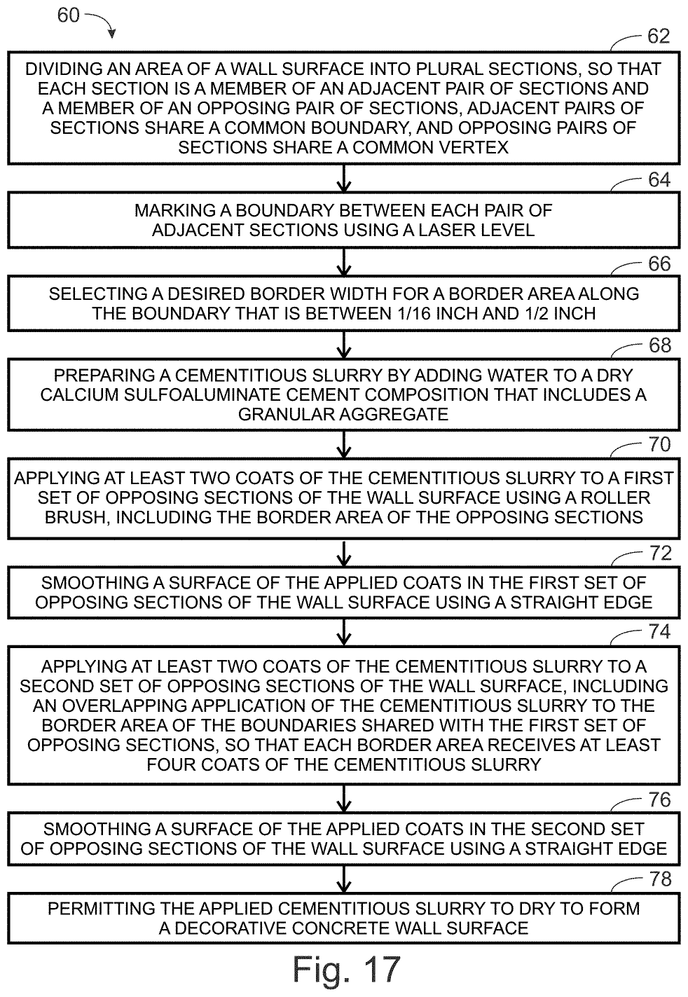

An alternative illustrative method of creating a decorative concrete wall surface is shown in flowchart 60 of FIG. 17. Flowchart 60 includes the steps of dividing an area of a wall surface into a plurality of sections so that each section is a member of an adjacent pair of sections and a member of an opposing pair of sections, where adjacent pairs of sections share a common boundary, and opposing pairs of sections share a common vertex, at step 62; marking a boundary between each pair of adjacent sections using a laser level, at step 64; selecting a desired border width area along the boundary between each pair of adjacent sections that is between 1/16 inch and ½ inch, at step 66; preparing a cementitious slurry by adding water to a dry calcium sulfoaluminate cement composition that includes a granular aggregate, at step 68; applying at least two coats of the cementitious slurry to a first set of opposing sections of the wall surface using a roller brush, including the border area of the opposing sections, at step 70; smoothing a surface of the applied coats in the first set of opposing sections of the wall surface using a straight edge, at step 72; applying at least two coats of the cementitious slurry to a second set of opposing sections of the wall surface using the roller brush, including an overlapping application of the cementitious slurry to the border area of the borders shared with the first set of opposing sections, such that each border area receives at least four coats of the cementitious slurry, at step 74; smoothing a surface of the applied coats in the second set of opposing sections of the wall surface using a straight edge, at step 76; and permitting the applied coats of the cementitious slurry to dry to form the decorative concrete wall surface at step 78.

The performance of methods of the present disclosure may be facilitated by one or more kits, where such kits include selected materials and tools for carrying out the desired method. In one embodiment, such kits may include one or more roller brushes; one or more masking materials; one or more mixing tools or mixing attachments for existing tools, such as a drill; one or more laser levels; one or more straight edges for smoothing the concrete surface; a painter's grid, a bucket or other container suitable for mixing the cementitious slurry, and an amount of calcium sulfoaluminate cement composition.

### Examples

This section describes additional aspects and features of the disclosed apparatus, systems, and methods presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A1. A method of creating a decorative concrete wall surface, including dividing an area of a wall surface into a plurality of sections; marking a boundary between each pair of adjacent sections; selecting a desired border width area along the boundary between each pair of adjacent sections; applying a cementitious slurry to each section of the wall surface using a roller brush, such that each section receives at least two coats of the cementitious slurry, and each border area receives at least four coats of the cementitious slurry; smoothing a surface of the applied cementitious slurry in each section; and permitting the applied cementitious slurry to dry to form the decorative concrete wall surface.
A2. The method of paragraph A1, where the wall surface is divided into a plurality of sections that are quadrilateral sections.
A3. The method of paragraph A1, where the wall surface is divided into a plurality of parallelogram sections having substantially equivalent areas.
A4. The method of paragraph A1, where the cementitious slurry is prepared by adding water to a dry cement composition containing a granular aggregate.
A5. The method of paragraph A1, where the cementitious slurry is prepared by adding water to a dry cement composition containing a granular aggregate that is a silica sand.
A6. The method of paragraph A1, where the cementitious slurry is prepared by adding water to a dry cement composition that is a calcium sulfoaluminate cement composition.
A7. The method of paragraph A1, where the step of marking the boundary between each pair of adjacent sections includes using a laser level.
A8. The method of paragraph A1, where the step of marking a boundary between each pair of adjacent sections includes marking the boundaries with a masking material.
A9. The method of paragraph A1, where the step of applying the cementitious slurry to each section of the wall surface includes applying the cementitious slurry to each of that sections adjacent border areas, such that each section of the wall surface receives at least two coats of the cementitious slurry, and each border area receives at least four coats of the cementitious slurry.
A10. The method of paragraph A1, where the desired border width is between 1/24 inch and ½ inch.
A11. The method of paragraph A1, where the desired border width is between 1/16 inch and ¼ inch.
B1. A method of creating a decorative concrete wall surface, including dividing an area of a wall surface into a plurality of sections so that each section is a member of an adjacent pair of sections and a member of an opposing pair of sections, where adjacent pairs of sections share a common boundary, and opposing pairs of sections share a common vertex; marking a boundary between each pair of adjacent sections using a laser level; selecting a desired border width area along the boundary between each pair of adjacent sections that is between 1/16 inch and ½ inch; preparing a cementitious slurry by adding water to a dry calcium sulfoaluminate cement composition that includes a granular aggregate; applying at least two coats of the cementitious slurry to a first set of opposing sections of the wall surface using a roller brush, including the border area of the opposing sections; smoothing a surface of the applied coats in the first set of opposing sections of the wall surface using a straight edge; applying at least two coats of the cementitious slurry to a second set of opposing sections of the wall surface using the roller brush, including an overlapping application of the cementitious slurry to the border area of the borders shared with the first set of opposing sections, such that each border area receives at least four coats of the cementitious slurry; smoothing a surface of the applied coats in the second set of opposing sections of the wall surface using a straight edge; and permitting the applied coats of the cementitious slurry to dry to form the decorative concrete wall surface.
B2. The method of paragraph B1, where the wall surface is divided into a plurality of substantially equivalent square or rectangular sections.
B3. The method of paragraph B1, where the step of preparing the cementitious slurry includes adding water to a dry calcium sulfoaluminate cement composition containing a granular aggregate that is a silica sand.
B4. The method of paragraph B1, where the step of marking a boundary between each pair of adjacent sections includes marking the boundaries with painter's tape.
C1. A decorative concrete wall surface, prepared by dividing an area of a wall surface into a plurality of sections; marking a boundary between each pair of adjacent sections; selecting a desired border width along the boundary between each pair of adjacent sections; applying a cementitious slurry to each section of the wall surface using a roller brush, such that each section receives at least two coats of the cementitious slurry, and each border receives at least four coats of the cementitious slurry; smoothing a surface of the applied cementitious slurry in each section; and permitting the applied cementitious slurry to dry to form the decorative concrete wall surface.
C2. The decorative concrete wall surface of paragraph C1, where the cementitious slurry is applied to a drywall or an engineered wood product.
C3. The decorative concrete wall surface of paragraph C1, where the cementitious slurry is applied to an engineered wood product that is plywood, oriented strand board, laminated veneer lumber, parallel strand lumber, and fiberboard.
C4. The decorative concrete wall surface of paragraph C1, where the desired border width is between 1/16 inch and ½ inch.

### CONCLUSION

The disclosure set forth above may encompass multiple distinct examples with independent utility. Although each of these has been disclosed in one or more illustrative form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A method of creating a decorative concrete wall surface, comprising:
dividing an area of a wall surface into a plurality of sections;
marking a boundary between each pair of adjacent sections;
selecting a desired border width area along the boundary between each pair of adjacent sections;
applying a cementitious slurry to each section of the wall surface using a roller brush, such that each section receives at least two coats of the cementitious slurry, and each border area receives at least four coats of the cementitious slurry;
smoothing a surface of the applied cementitious slurry in each section; and
permitting the applied cementitious slurry to dry to form the decorative concrete wall surface.

2. The method of claim 1, wherein the wall surface is divided into a plurality of sections that are quadrilateral sections.

3. The method of claim 1, wherein the wall surface is divided into a plurality of parallelogram sections having substantially equivalent areas.

4. The method of claim 1, wherein the cementitious slurry is prepared by adding water to a dry cement composition containing a granular aggregate.

5. The method of claim 1, wherein the cementitious slurry is prepared by adding water to a dry cement composition containing a granular aggregate that is a silica sand.

6. The method of claim 1, wherein the cementitious slurry is prepared by adding water to a dry cement composition that is a calcium sulfoaluminate cement composition.

7. The method of claim 1, wherein the step of marking the boundary between each pair of adjacent sections includes using a laser level.

8. The method of claim 1, wherein the step of marking a boundary between each pair of adjacent sections includes marking the boundaries with a masking material.

9. The method of claim 1, wherein the step of applying the cementitious slurry to each section of the wall surface includes applying the cementitious slurry to each of that sections adjacent border areas, such that each section of the wall surface receives at least two coats of the cementitious slurry, and each border area receives at least four coats of the cementitious slurry.

10. The method of claim 1, wherein the desired border width is between 1/24 inch and ½ inch.

11. The method of claim 1, wherein the desired border width is between 1/16 inch and ¼ inch.

12. A method of creating a decorative concrete wall surface, comprising:
dividing an area of a wall surface into a plurality of sections so that each section is a member of an adjacent pair of sections and a member of an opposing pair of sections, where adjacent pairs of sections share a common boundary, and opposing pairs of sections share a common vertex;
marking a boundary between each pair of adjacent sections using a laser level;
selecting a desired border width area along the boundary between each pair of adjacent sections that is between 1/16 inch and ½ inch;
preparing a cementitious slurry by adding water to a dry calcium sulfoaluminate cement composition that includes a granular aggregate;
applying at least two coats of the cementitious slurry to a first set of opposing sections of the wall surface using a roller brush, including the border area of the opposing sections;
smoothing a surface of the applied coats in the first set of opposing sections of the wall surface using a straight edge;
applying at least two coats of the cementitious slurry to a second set of opposing sections of the wall surface using the roller brush, including an overlapping application of the cementitious slurry to the border area of the boundaries shared with the first set of opposing sections, such that each border area receives at least four coats of the cementitious slurry;
smoothing a surface of the applied coats in the second set of opposing sections of the wall surface using a straight edge; and
permitting the applied coats of the cementitious slurry to dry to form the decorative concrete wall surface.

13. The method of claim 12, wherein the wall surface is divided into a plurality of substantially equivalent square or rectangular sections.

14. The method of claim 12, wherein the step of preparing the cementitious slurry includes adding water to a dry calcium sulfoaluminate cement composition containing a granular aggregate that is a silica sand.

15. The method of claim 12, wherein the step of marking a boundary between each pair of adjacent sections includes marking the boundaries with painter's tape.

16. A decorative concrete wall surface, prepared by:
dividing an area of a wall surface into a plurality of sections;
marking a boundary between each pair of adjacent sections;
selecting a desired border width along the boundary between each pair of adjacent sections;
applying a cementitious slurry to each section of the wall surface using a roller brush, such that each section receives at least two coats of the cementitious slurry, and each border receives at least four coats of the cementitious slurry;
smoothing a surface of the applied cementitious slurry in each section; and
permitting the applied cementitious slurry to dry to form the decorative concrete wall surface.

17. The decorative concrete wall surface of claim 16, wherein the cementitious slurry is applied to a drywall or an engineered wood product.

18. The decorative concrete wall surface of claim 16, wherein the cementitious slurry is applied to an engineered wood product that is plywood, oriented strand board, laminated veneer lumber, parallel strand lumber, and fiberboard.

19. The decorative concrete wall surface of claim 16, wherein the desired border width is between 1/16 inch and ½ inch.
